(19) United States
(12) Patent Application Publication
(10) Pub. No.: US 2008/0104547 A1
(43) Pub. Date: May 1, 2008

(54) GESTURE-BASED COMMUNICATIONS

(75) Inventors: Mark Morita, Arlington Heights, IL (US); Murali Kumaran Kariathungal, Hoffman Estates, IL (US); Steven Phillip Roehm, Waukesha, WI (US); Prakash Mahesh, Hoffman Estates, IL (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/552,815

(22) Filed: Oct. 25, 2006

(51) Int. Cl. G06K 9/00; G06F 3/033

(52) U.S. Cl. 715/863; 382/187

(57) ABSTRACT

Application workflows can be improved using gesture recognition. Interpreting non-functional attributes of gestures, such as relative sizes and/or positions and/or locations, can indicate relative degrees of functionality of the gesture. Thus, gesture inputs trigger proportionate functionality at an application, whereby the gesture input can include a gesture component and at least one of a size component and/or a position component modifying the gesture component.

### RELATED APPLICATIONS

### FEDERALLY SPONSORED RESEARCH OR DEVELOPMENT

### MICROFICHE/COPYRIGHT REFERENCE

### FIELD OF INVENTION

In general, the inventive arrangements relate to application workflows, and more specifically, to gesture-based communications to improve application workflows.

### BACKGROUND OF INVENTION

Clinical and healthcare environments are crowded, demanding environments that can benefit from improved organization and ease of use of imaging systems, data storage systems, and other like equipment used therein. In fact, a healthcare environment, such as a hospital or clinic, can encompass a large array of professionals, patients, and equipment, and healthcare personnel must manage numerous patients, systems, and tasks in order to provide quality service. Unfortunately, however, healthcare personnel also encounter numerous difficulties or obstacles in their workflow.

In a clinical or healthcare environment, such as a hospital, large numbers of employees and patients can result in confusion or delay when trying to reach other medical personnel for examination, treatment, consultation, referrals, and/or the like. A delay in contacting other medical personnel can result in further injury or death to a patient. Additionally, a variety of distractions in clinical environments frequently interrupt medical personnel and can interfere with their job performance. Furthermore, healthcare workspaces, such as radiology workspaces, can become cluttered with a variety of monitors, data input devices, data storage devices, and/or communication devices, for example. Cluttered workspaces can result in inefficient workflows and impact service to clients, which can impact patient health and safety and/or result in liability for a healthcare facility.

Data entry and access can also be particularly complicated in a typical healthcare facility. Speech transcription or dictation is typically accomplished by typing on a keyboard, dialing a transcription service, using a microphone, using a Dictaphone, and/or using digital speech recognition software at a personal computer. Such dictation usually involves a healthcare practitioner sitting in front of a computer or using a telephone, which can be impractical during operational situations. Similarly, for access to electronic mail and/or voice mail messages, practitioners typically use a computer or telephone in the facility. Access outside of the facility or away from a computer or telephone is often limited.

Thus, managing multiple and disparate devices to perform daily tasks, positioned within an already crowded environment, can be difficult for medical and healthcare professionals. Additionally, a lack of interoperability between devices can increase delays and inconveniences associated with using multiple devices in healthcare application workflows. Using multiple devices, for example, can also involve managing multiple logons within the same environment. Thus, improving the ease of use and interoperability between multiple devices in a healthcare environment remains desirable.

Healthcare environments involve interacting with numerous devices, such as keyboards, computer mousing devices, imaging probes, surgical equipment, and the like, whereby repetitive motion disorders can often result. Accordingly, eliminating repetitive motions in order to minimize repetitive motion injuries is desirable.

Healthcare environments, such as hospitals and/or clinics, can include clinical information systems, such as hospital information systems (“HIS”) and radiology information systems (“RIS”), as well as storage systems, such as picture archiving and communication systems (“PACS”). Information stored may include patient medical histories, imaging data, test results, diagnosis information, management information, and/or scheduling information, for example. The information can be centrally stored or divided among multiple locations. And healthcare practitioners may need to access patient information and/or other information at various points in the healthcare workflow. For example, during surgery, medical personnel may need to access a particular patient's information, such as images of the patient's anatomy, that are stored in a medical information system. Alternatively, medical personnel may need or want to enter new information, such as histories, diagnostics, or treatment information, into the medical information system during an on-going medical procedure.

In current information systems, such as PACS, information is often entered and/or retrieved using a local computer terminal with a keyboard and/or mouse. During a medical procedure, and at other times in the medical workflow, however, physical use of a keyboard, mouse, or other similar devices can be impractical (e.g., located in a different room) and/or unsanitary (e.g., violating the sterile integrity of the patient and/or clinician). Re-sterilizing after using local computer equipment, however, is often impractical for medical personnel in an operating room, for example, and it can discourage medical personnel from accessing otherwise appropriate medical information systems. Thus, providing facilitated access to a medical information system without physical contact remains desirable, particularly when striving to maintain sterile fields and improve medical workflows.

Imaging systems are complicated to configure and operate. Oftentimes, healthcare personnel may need to obtain an image of a patient, reference and/or update a patient's records and/or diagnosis, and/or order additional tests and/or consultations. Thus, there is a need to facilitate operation and interoperability of imaging systems and related devices in the healthcare environment and elsewhere.

In many situations, an operator of an imaging system may experience difficulty when scanning a patient or other object using an imaging system console. For example, using an imaging system, such as an ultrasound imaging system for upper and lower extremity exams, compression exams, carotid exams, neo-natal head exams, and/or portable exams, may be difficult with typical system consoles. Operators may not be able to physically reach both the console and the patient location to be scanned. Additionally, operators may not be able to adjust patients being scanned and operate the system console simultaneously. Operators may also be unable to reach a telephone or computer terminal to access information and/or order tests and/or consultations. Providing additional operators or assistants to assist with examinations, however, can increase the cost of the examination and introduce errors and/or unusable data due to miscommunications. Accordingly, increased facilitation of operating imaging systems and related services remains desirable.

Additionally, image volume for acquisition and radiologist reviews continues to increase. PACS imaging tools have increased in complexity as well. Thus, interactions with standard input devices (e.g., mouse, trackballs, etc.) have become increasingly more difficult. Radiologists have noted a lack of sufficient ergonomics with respect to standard input devices, such as a mouse, trackballs, etc. Scrolling through large datasets by manually cine-ing or scrolling, repeating mouse movements, and/or other current techniques have resulted in carpel tunnel syndrome and other repetitive stress syndromes. Unfortunately, however, most radiologists have not been able to leverage other more ergonomic input devices (e.g., joysticks, video editors, game pads, etc.), as many of the devices are not usually custom-configurable for PACS and/or other healthcare applications.

Tablets, such as Wacom tablets, have been used in graphic arts, but they currently tend to lack sufficient applicability and/or interactivity with other applications, such as healthcare applications. Handheld devices, such as personal digital assistants and/or pocket PCs, have been used for general scheduling and note-taking, but they have not yet been satisfactorily adapted to general healthcare use and/or interaction with healthcare application workflows.

Devices facilitating gesture-based interactions typically allow motion-based interactions, whereby users write or motion a character or series of characters to correspond to specific software functions. Gesture recognition algorithms typically attempt to recognize the characters or patterns gestured by the user. Typical gesture recognition systems focus on recognizing the gestured character alone. In the case of an image magnify, for example, a user may gesture the letter “z.” The gesture-enabled image processing or display system often then responds by generically zooming the image. Unfortunately, however, such a system will be unaware of a specific level of zoom that a user is requesting from this gesture based interaction. If a user would like to further zoom in on an image, then the user must usually repeatedly gesture the letter “z” in order to zoom to a desired level. Such repetition may not only be time consuming, but it may also tire the user.

As discussed above, many clinicians, and especially surgeons, are often challenged with maintaining a sterile environment when using conventional computer equipment, such as a mouse and/or keyboard. Several approaches have been proposed to address the desire to maintain sterile clinical environments, such as using a sterile mouse and/or keyboards, gesture recognition, gaze detections, thin-air displays, voice commands, etc. However, known problems remain with many of these approaches. For example, while voice commands appears to provide limited solutions, they can be prone to confusion and interference, particularly due to proximity issues and the presence of multiple people in an operating room. Similarly, thin-air displays tend to require complex interaction with computers within the clinical environment.

Thus, there is a need to improve healthcare workflows using gesture recognition techniques and other interactions. Accordingly, streamlining gesture-based controls remains desirable.

### SUMMARY OF INVENTION

Certain embodiments of the inventive arrangements interpret non-functional attributes of a gesture as indicative of a relative degree of functionality of the gesture. Certain attributes can include size and/or position.

Certain embodiments include an interface for receiving non-functional attributes of a gesture and an application for interpreting the non-functional attributes as indicative of a relative degree of functionality of the gesture. Again, certain of these attributes can include size and/or position, and the application can respond to the non-functional attributes in proportion to the relative degree of functionality.

Certain embodiments relate to application workflow using gesture recognition. For example, a communication link between an interface and an application can be provided. Gestured inputs can trigger functionality at the application via the communication link. The gesture input can include a gesture component and at least one of a size component and a position component modifying the gesture component.

Certain embodiments provide a computer-readable medium having a set of instructions for execution on a computer. The set of instructions includes an input routine configured to receive gesture-based input on an interface. The input routine can capture a gesture and a characteristic associated with the gesture as the gesture-based input. The set of instructions can also include a translation routine configured to translate between the gesture-based input and the application function. The translation routine can modify the application function corresponding to the gesture of the gesture-based input with the characteristic of the gesture-based input.

Certain embodiments associate a gesture with an application function, mapping gestures to application functions. The mapping can be modified based on a characteristic associated with the gesture, and the modified mappings can be stored.

### BRIEF DESCRIPTION OF SEVERAL VIEWS OF THE DRAWINGS

A clear conception of the advantages and features constituting inventive arrangements, and of various construction and operational aspects of typical mechanisms provided by such arrangements, are readily apparent by referring to the following illustrative, exemplary, representative, and non-limiting figures, which form an integral part of this specification, in which like numerals generally designate the same elements in the several views, and in which:

FIG. 1 illustrates an input and control system in which the inventive arrangements can be practiced;

FIG. 2 illustrates an interface of FIG. 1;

FIG. 3 illustrates a graffiti that can be received at the interface of FIG. 2;

FIG. 4 illustrates a flow diagram for implementing gesture-based communications;

FIG. 5 illustrates interpreting a relative size of a gesture as indicating a relative degree of functionality of the gesture;

FIG. 6 illustrates interpreting a relative position of a gesture as indicating a relative degree of functionality of the gesture; and

FIG. 7 illustrates a flow diagram for mapping gesture-based communications.

### DETAILED DESCRIPTION OF VARIOUS PREFERRED EMBODIMENTS

Referring now to the figures, preferred embodiments of the inventive arrangements will be described in terms of a healthcare application. However, the inventive arrangements are not limited in this regard. For example, while variously described embodiments may provide embodiments for healthcare applications, other contexts are also hereby contemplated, including various other consumer, industrial, radiological, and communication systems, and the like.

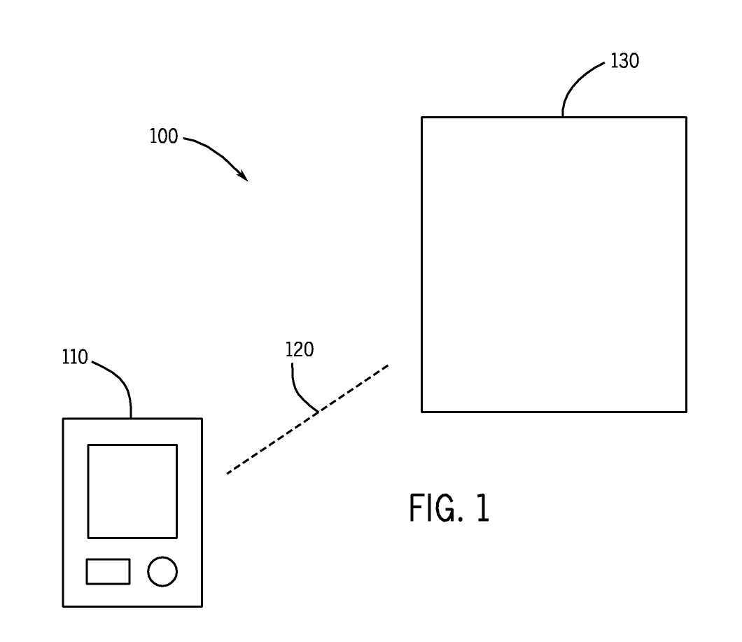

FIG. 1 illustrates an information input and control system 100 in which the inventive arrangements can be practiced. More specifically, the system 100 includes an interface 110, communication link 120, and application 130. The components of the system 100 can be implemented in software, hardware, and/or firmware, as well as in various combinations thereof and the like, as well as implemented separately and/or integrated in various forms, as needed and/or desired.

The communication link 120 connects the interface 110 and application 130. Accordingly, it can be a cable link or wireless link. For example, the communication link 120 could include one or more of a USB cable connection or other cable connection, a data bus, an infrared link, a wireless link, such as Bluetooth, WiFi, 802.11, and/or other data connections, whether cable, wireless, or other. The interface 110 and communication link 120 can allow a user to input and retrieve information from the application 130, as well as to execute functions at the application 130 and/or other remote systems (not shown).

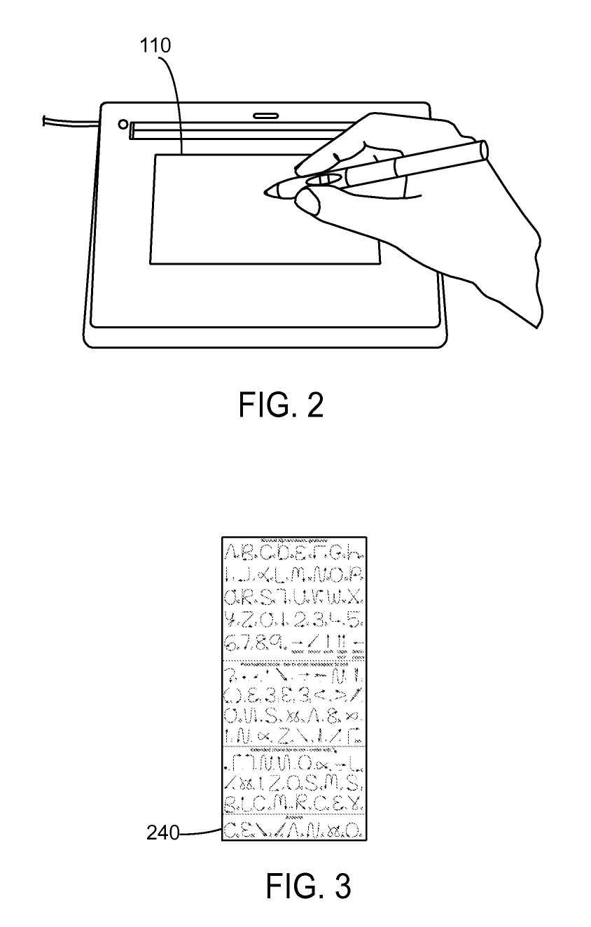

Preferably, the interface 110 includes a user interface, such as a graphical user interface, that allows a user to input information, retrieve information, activate application functionality, and/or otherwise interact with the application 130. As illustrated in FIG. 2, for example, a representative interface 110 may include a tablet-based interface with a touchpad capable of accepting stylus, pen, keyboard, and/or other human touch and/or human-directed inputs. As such, the interface 110 may be used to drive the application 130 and serve as an interaction device to display and/or view and/or interact with various screen elements, such as patient images and/or other information. Preferably, the interface 110 may execute on, and/or be integrated with, a computing device, such as a tablet-based computer, a personal digital assistant, a pocket PC, a laptop, a notebook computer, a desktop computer, a cellular phone, and/or other computing systems. As such, the interface 110 preferably facilitates wired and/or wireless communication with the application 130 and provides one or more of audio, video, and/or other graphical inputs, outputs, and the like.

The interface 110 and communication link 120 may also include multiple levels of data transfer protocols and data transfer functionality. They may support one or more system-level profiles for data transfer, such as an audio/video remote control profile, a cordless telephony profile, an intercom profile, an audio/video distribution profile, a headset profile, a hands-free profile, a file transfer protocol, a file transfer profile, an imaging profile, and/or the like. The interface 110 and communication link 120 may be used to support data transmission in a personal area network (PAN) and/or other network.

In one embodiment, graffiti-based stylus and/or pen interactions, such as the graffiti 240 shown in FIG. 3, may be used to control functionality at the interface 110 and/or application 130 via the communication link 120. Graffiti 240 and/or other strokes may be used to represent and/or trigger one or more commands, command sequences, workflows, and/or other functionality at the interface 110 and/or application 130, for example. That is, a certain movement or pattern of a cursor displayed on the interface 110 may correspond to or trigger a command or series of commands at the interface 110 and/or application 130. Interactions triggered by graffiti 240 and/or other gestures and/or strokes may be customized for specific applications 130 (e.g., healthcare) and/or for particular users and/or for groups of users, for example. Graffiti 240 and/or other gestures and/or strokes may also be implemented in a variety of languages instead of, or in addition, to English, for example. Graffiti 240 interactions and/or shortcuts may also be mapped to keyboard shortcuts, program macros, and/or other specific interactions, for example, as needed and/or desired.

A preferred application 130 may be a healthcare software application, such as an image/data viewing application, an image/data analysis application, an annotation and/or reporting application, and/or other patient and/or practice management applications. In such an embodiment, the application 130 may include hardware, such as a PACS workstation, advantage workstation (“AW”), PACS server, image viewer, personal computer, workstation, server, patient monitoring system, imaging system, and/or other data storage and/or processing devices, for example. The interface 110 may be used to manipulate functionality at the application 130 including, but not limited to, for example, an image zoom (e.g., single or multiple zooms), application and/or image resets, display window/level settings, cines/motions, magic glasses (e.g., zoom eyeglasses), image/document annotations, image/document rotations (e.g., rotate left, right, up, down, etc.), image/document flipping (e.g., flip left, right, up, down, etc.), undo, redo, save, close, open, print, pause, indicate significance, etc. Images and/or other information displayed at the application 130 may be affected by the interface 110 via a variety of operations, such as pan, cine forward, cine backward, pause, print, window/level, etc.

In one embodiment, graffiti 240 and/or other gestures and/or indications may be customizable and configurable by a user, a group of users, and/or an administrator, for example. A user may create one or more strokes and/or functionality corresponding to the one or more strokes, for example. In one embodiment, the system 100 may provide a default configuration of strokes and/or corresponding functionalities. A user, such as an authorized user, may then create the user's own graffiti 240 and/or functionality and/or modify default configurations of functionality and corresponding graffiti 240, for example. Users may also combine sequences of workflows of actions and/or functionality into a single gesture and/or graffiti 240, for example.

In one embodiment, a password or other authentication, such as voice or other biometric authentication, may also be used to establish a connection between the interface 110 and the application 130 via the communication link 120. Once a connection has been established between the interface 110 and the application 130, commands may then be passed between the interface 110 and application 130 via the communication link 120.

In operation, for example, a radiologist, surgeon, or other healthcare practitioner may use the interface 110 in an operating room. For example, a surgeon may request patient data, enter information about a current procedure, enter computer commands, and/or receive patient data using the interface 110. To request patient data and/or enter computer commands, the surgeon can “draw” and/or otherwise indicate a stroke or graffiti motion at or on the interface 110. Then, the request or command can be transmitted from the interface 110 to the application 130 via the communication link 120. The application 130 can then execute one or more commands received from the interface 110 via the communication link 120. If the surgeon, for example, requests patient information, then the application 130 can retrieve that information. The application 130 may then transmit the patient information back to the interface 110 via the communication link 120. Alternatively, or in addition thereto, the information may also be displayed at one or more of the interface 110, the application 130, and/or other remote systems (not shown). Thus, requested information and/or functions and/or results may be displayed at one or more of the interface 110, the application 130, and/or other displays, for example.

In one embodiment, when a surgeon or other healthcare practitioner sterilizes before a procedure, the interface 110 may be sterilized as well. Thus, a surgeon may use the interface 110 in a hygienic environment to access information or enter new information during a procedure, rather than touch an unsterile keyboard and/or mouse and/or the like for the application 130.

In certain embodiments, a user may interact with a variety of electronic devices and/or applications using the interface 110. For example, a user may manipulate functionality and/or data at one or more applications 130 and/or systems via the interface 110 and communication link 120. The user may also retrieve data, including images and/or related data, from one or more systems and/or applications 130 using the interface 110 and/or communication link 120.

For example, a radiologist may carry a wireless-enabled tablet PC and enter a radiology reading room to review and/or enter image data. A computer in the room running the application 130 may recognizes the radiologist's tablet PC interface 110 via the communication link 120. That is, data can be exchanged between the radiologist's tablet PC interface 110 and the computer via the communication link 120 to allow the interface 110 and the application 130 to synchronize. The radiologist may then able to access the application 130 via the tablet PC interface 110 using strokes/gestures on or at the interface 110. The radiologist may, for example, view, modify, and/or print images and reports, for example, using graffiti 240 via the tablet PC interface 110 and/or the communication link 120.

Preferably, the interface 110 can enable the radiologist to eliminate excess clutter in a radiology workspace by replacing the use of a telephone, keyboard, mouse, etc. with the interface 110. The interface 110 and communication link 120 may further simplify interaction with the one or more applications 130 and/or devices and simplify the radiologist's workflow through the use of a single interface 110 and/or simplified gestures/strokes representing one or more commands and/or functions thereat.

In certain embodiments, interface strokes may be used to navigate through clinical applications, such as a PACS system, radiology information system (“RIS”), hospital information system (“HIS”), electronic medical record (“EMR”), and/or the like. A user's gestures/graffiti 240 can be used to execute one or more commands within the system 100, transmit data to be recorded by the system 100, and/or retrieve data, such as patient reports or images, from the system 100, for example.

In certain embodiments, the system 100 may also include voice command and control capabilities. For example, spoken words may be converted to text for storage and/or display at the application 130. Additionally, text at the application 130 may be converted to audio for playback to a user at the interface 110 via the communication link 120. Dictation may be facilitated using voice recognition software on the interface 110 and/or application 130. Translation software may allow dictation, as well as playback, of reports, lab data, examination notes, and/or image notes, for example. Audio data may be reviewed in real-time via the system 100. For example, a digital sound file of a patient's heartbeat may be reviewed by a physician remotely through the system 100.

The interface 110 and communication link 120 may also be used to communicate with other medical personnel. Certain embodiments may improve reporting by healthcare practitioners and/or allow immediate updating and/or revising of reports using gestures and/or voice commands. For example, clinicians may order follow-up studies at a patient's bedside or during rounds without having to locate a mouse or keyboard. Additionally, reports may be signed electronically, eliminating delay and/or inconvenience associated with written signatures.

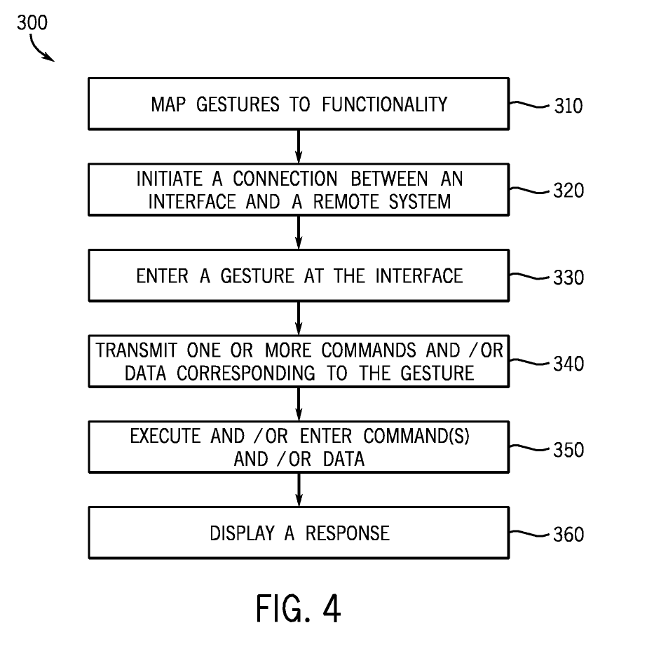

Referring now to FIG. 4, a flow diagram 300 is illustrated for implementing gesture-based communications in accord with the inventive arrangements. For example, at a step 310, one or more gestures can be mapped to one or more functionalities. For example, a gesture indicating a rudimentary representation of an anatomy, such as a breast, may retrieve and display a series of breast exam images for a particular patient. Other exemplary gestures and corresponding functionality may include, but are not limited to, gesturing a diagonal line from left to right to zoom in on an image, a diagonal line from right to left to zoom out on an image, a counterclockwise semi-circle to rotate and 3-D reformat an image counterclockwise, a clockwise semi-circle to rotate and 3-D reformat an image clockwise, a series of circles to indicate a virtual colonoscopy sequence, a gesture indicating a letter “B” to signify automatic bone segmentation in one or more images, and the like.

In certain embodiments, a series and/or workflow of functionalities may be combined into a signal stroke and/or gesture. For example, a stroke made over an exam image may automatically retrieve related historical images and/or data for a particular anatomy and/or patient. A stroke made with respect to an exam may automatically cine through images in the exam and generate a report based on those images and analysis, for example. A stroke may be used to provide structured and/or standard annotation in an image and/or generate a report, such as a structured report, for image analysis. Strokes may be defined to correspond to standard codes, such as Current Procedural Terminology (“CPT”), International Classification of Diseases (“ICD”), American College of Radiology (“ACR”), Digital Imaging and Communications in Medicine (“DICOM”), Health Level Seven (“HL7”), and/or American National Standards Institute (“ANSI”) codes, and/or orders, and/or the like, for example. Strokes may be defined to correspond to any functionality and/or series of functionalities in a given application 130, for example.

In one embodiment, a default configuration of strokes and/or functionality may be provided. In one embodiment, a default configuration may be modified and/or customized for a particular user and/or group of users, for example. In one embodiment, additional strokes and/or functionality may be defined by and/or for a user and/or group of users, for example.

Referring again to FIG. 4, at a step 320, a connection (such as the communication link 120 of FIG. 1) can be initiated between an interface (such as the interface 110 of FIG. 1) and a remote system (such as the application 130 of FIG. 1). Data packets can then be transmitted between the interface (e.g., 110) and remote system (e.g., application 130) through the communication link (e.g., 120) therebetween. This communication link (e.g., 120) can also be authenticated using voice identification and/or a password, for example. The connection may be established using a wired or wireless communication link, such as the communication link 120 of FIG. 1. After the communication link (e.g., 120) has been established, a user may interact with and/or affect the remote system (e.g., application 130) via the interface (e.g., 110).

Next, at a step 330, a user can gesture at the interface (e.g., 110). For example, the user can enter graffiti 240 (see FIG. 3) and/or other strokes using a pen, stylus, finger, touchpad, etc., at or towards an interface screen of the interface (e.g., 110). In one embodiment, a mousing device may be used to gesture on the interface display, for example. The gesture can correspond to a desired action at the remote system (e.g., application 130). The gesture may also correspond to a desired action at the interface (e.g., 110). A gesture may also correspond to one or more commands and/or actions for execution at the interface (e.g., 110) and/or remote system (e.g., application 130), for example.

Then, at a step 340, a command and/or data corresponding to the gesture can be transmitted from the interface (e.g., 110) to the remote system (e.g., application 130). If the gesture is related to functionality at the interface (e.g., 110), then the gesture can be translated into a command and/or data at same. In certain embodiments, for example, a table and/or other data structure can store a correlation between a gesture and/or one or more commands, actions, and/or data, which are to be input and/or implemented as a result of the gesture. When a gesture is recognized by the interface (e.g., 110), then the gesture can be translated into a corresponding command and/or data for execution by a processor and/or application at the interface (e.g., 110) and/or remote system (e.g., application 130).

At a step 350, the command and/or data can be executed and/or entered at the remote system (e.g., application 130). In one embodiment, if a command and/or data were intended for local execution at the interface (e.g., 110), then the command and/or data could be executed and/or entered at the interface (e.g., 110). Data could be entered, retrieved, and/or modified at the interface (e.g., 110) and/or the remote system (e.g., application 130), based on the gesture, for example, as desired. An application and/or functionality may be executed at the interface (e.g., 110) and/or remote system (e.g., application 130) in response to the gesture, for example. In one embodiment, a plurality of data and/or functionality may be executed at the interface (e.g., 110) and/or remote system (e.g., application 130) in response to a gesture, for example.

Next, at a step 360, a response can be displayed. This response may be displayed, for example, at the interface (e.g., 110) and/or at the remote system (e.g., application 130). For example, data and/or application results may be displayed at the interface (e.g., 110) and/or remote system (e.g., application 130) as a result of commands and/or data executed and/or entered in response to a gesture. A series of images may be shown and/or modified, for example. Data may be entered into an image annotation and/or report, for example. One or more images may be acquired, reviewed, and/or analyzed according to one or more gestures, for example. For example, a user using a pen to draw a letter “M” or other symbol on an interface display may result in magnification of patient information and/or images on an interface (e.g., 110) and/or remote system (e.g., application 130).

In certain embodiments, graffiti and/or gesture based interactions can be used as symbols for complex, multi-step macros in addition to 1-to-1 keyboard or command mappings. A user may be afforded greater specificity by modifying a graffiti/gesture-based command/action based on a size and/or position of a character/gesture performed.

For example, a level of zoom that a user desires with respect to an image can be determined by the size of the character “z” gestured on the image. For example, if a user wants to zoom to a smaller degree, then the user can gesture a smaller sized “z.” Or, if a user wants to zoom to a medium degree, then the user can gesture a medium sized “z.” Or, if a user wants to zoom to a larger degree, then the user can gesture a larger sized “z,” and so forth.

The position of a gesture can also modify a gesture. For example, zooming in on a lower left quadrant of an image may allow the user to affect and zoom in on the lower left quadrant of the image. Or, zooming in on an upper right quadrant of the image may allow the user to affect and zoom in on the upper right quadrant of the image, and so forth.

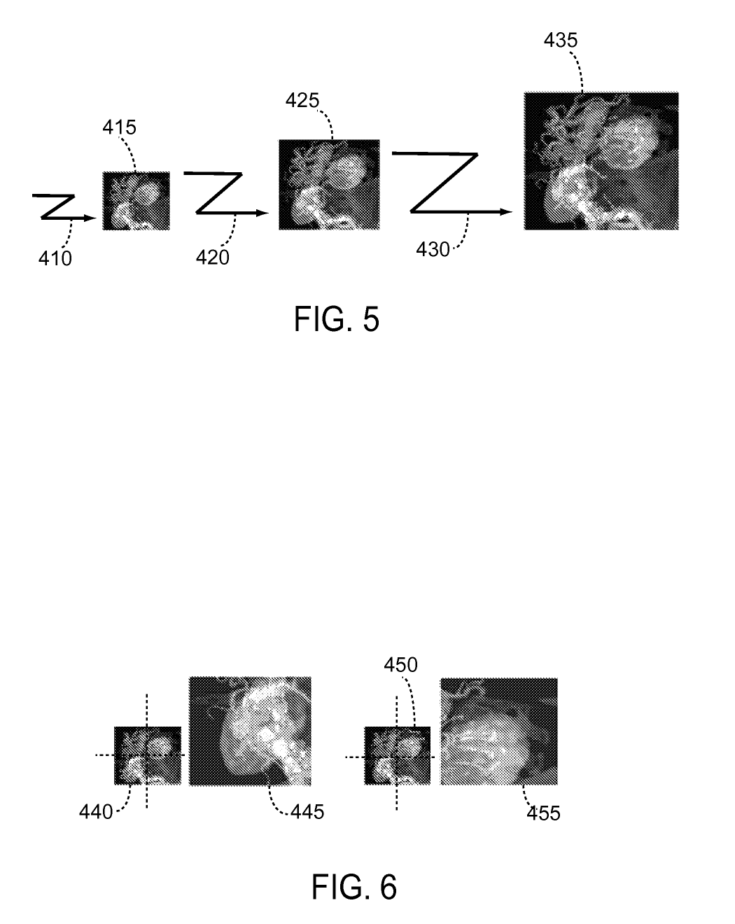

Referring now to FIG. 5, for example, it illustrates interpreting a relative size of a gesture as indicating a relative degree of functionality of the gesture. More specifically, as shown in the left panel of FIG. 5, a smaller “z” gesture 410 in conjunction with an image can result in a smaller zoom effect 415. As shown in the middle panel, a medium-sized “z” gesture 420 can result in a medium-sized zoom effect 425. And as shown in the right panel, a larger “z” gesture 430 can result in a larger-sized zoom effect 435. Accordingly, proportional effects can be obtained in relative proportion to the size of the given gesture. In other words, the size of the gesture can modify the size of the effect of the gesture.

And likewise, referring now to FIG. 6, for example, it illustrates interpreting a relative position of a gesture as indicating a relative degree of functionality of the gesture. More specifically, as shown in the left panel of FIG. 6, a “z” gesture in a lower left quadrant 440 of an image can result in a zoom effect 445 of the lower left quadrant of the image. And as shown in the right panel, a “z” gesture in an upper right quadrant 450 of an image can result in a zoom effect 455 of the upper right quadrant of the image. Accordingly, position and/or location effects can be obtained relative to the position and/or location of the given gesture. In other words, the position and/or location of the gesture can modify the position and/or location of the effect of the gesture.

As described, these proportional and position/location effects can be used separately and/or together in various fashions.

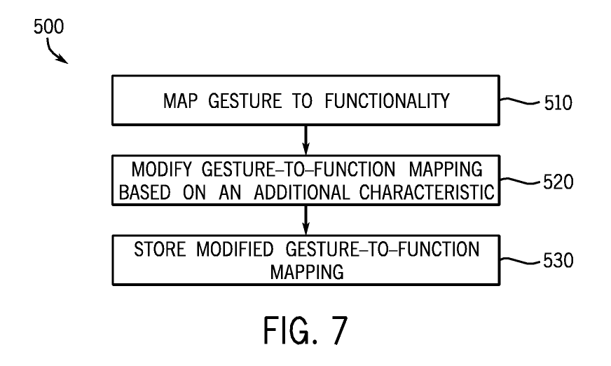

Referring now to FIG. 7, it illustrates a flow diagram 500 for mapping gesture-based communications in accord with the inventive arrangements. For example, at a step 510, a gesture can be mapped to an application function 130. For example, the gesture or character “z” can be mapped to a zoom or magnify command in an image processing or review application 130. At a step 520, the gesture-to-function mapping can be modified based on an additional characteristic associated with the gesture/graffiti 240. For example, the size of a gestured “z” can be mapped to a certain degree of zoom (e.g., a “normal” sized “z” can correspond to a certain degree of zoom, while a smaller “z” and larger “z” can respectively correspond to an order of magnitude of smaller and larger zooms of an image). As another example, the position of a gestured “z” can be mapped to a certain area of zoom (e.g., a gestured “z” in a specific quadrant of an image can correspond to a zoom of that quadrant of the image). In certain embodiments, a plurality of characteristics (e.g., size and position/location) can be combined to modify gesture-to-function mappings. Additionally, although a “z” gesture and image zoom command have been used above, it is understood that use of “z” and zoom is for the purposes of illustration only, and the inventive arrangements can be implemented using many other gesture-based commands as well (e.g., gesturing a “c” to cine a series of images, an “m” to magnify an image, a “s” for segmentation, a “b” for bone segmentation, etc.).

Referring again to FIG. 7, at a step 530, the modified gesture-to-function mapping can be stored for future use. In certain embodiments, the mappings may also be later modified by a user and/or tailored for a particular user and/or group of users according to a profile and/or single-session modification. In certain embodiments, mappings may be dynamically created for single-session uses and/or dynamically created and saved for further future uses as well, for example.

In general, the inventive arrangements relate to application workflows, and more specifically, to gesture-based communications to improve application workflows.

Thus, certain embodiments provide improved and/or simplified application workflows, and more specifically, gesture-based communications to improve the workflows. Representative embodiments can be used in healthcare and/or clinical environments, such as radiology and/or surgery. Certain embodiments allow a user to operate a single interface device to access functionality and transfer data via gestures and/or other strokes, in which non-functional attributes can indicate a relative degree of functionality of a gesture.

Certain embodiments increase efficiency and throughput for medical personnel, such as radiologists and physicians. Inventive arrangement can reduce desktop and operating room clutter, for example, and provide simplified interaction with applications and data. Repetitive motions and/or injuries associated therewith can also be reduced and/or eliminated by the inventive arrangements.

Certain embodiments leverage portable input devices, such as tablet and handheld computing devices, as well as graffiti 240 and/or gesture-based interactions, with both portable and desktop computing devices, to preferably interact with and control applications and workflows.

Certain embodiments provide an interface with graffiti 240 and/or gesture-based interactions, allowing users to design custom shortcuts for functionality and combinations/sequences of functionality to improve application workflows and simplify user interaction with such applications.

Certain embodiments facilitate interaction through stylus and/or touch-based interfaces with graffiti/gesture-based interactions that allow users to design custom shortcuts for existing menu items and/or other functionalities. Certain embodiments facilitate definition and use of gestures in one or more languages. Certain embodiments provide ergonomic and intuitive gesture shortcuts to help reduce carpel tunnel syndrome and other repetitive injuries and/or the like. Certain embodiments provide use of a portable interface to retrieve, review, and/or diagnose images at an interface or other display and/or the like. Certain embodiments allow graffiti and/or other gestures to be performed directly on top of or near an image and/or document to manipulate the image and/or document.

Certain embodiments reduce repetitive motions and gestures to allow more precise interactions. Certain embodiments allow users to add more specific controls to gestural inputs through additional cues based on size and/or position and/or locations of the gesture-based input.

Certain embodiments provide sterile user interfaces for use by surgeons and/or clinicians and the like in sterile environments. Certain embodiments provide gesture-based communications that can be used in conjunction with a display to display and modify images and/or other clinical data. Certain embodiments provide easy to use and effective user interfaces. Additionally, although certain embodiments were representatively described in reference to healthcare and/or clinical applications, the gesture-based interaction techniques described herein may be used in numerous applications in addition to healthcare applications.

It should be readily apparent that this specification describes illustrative, exemplary, representative, and non-limiting embodiments of the inventive arrangements. Accordingly, the scope of the inventive arrangements are not limited to any of these embodiments. Rather, various details and features of the embodiments were disclosed as required. Thus, many changes and modifications—as readily apparent to those skilled in these arts—are within the scope of the inventive arrangements without departing from the spirit hereof, and the inventive arrangements are inclusive thereof. Accordingly, to apprise the public of the scope and spirit of the inventive arrangements, the following claims are made:

1. A gesture-based communication system, comprising:
an interface for receiving at least one or more non-functional attributes of a gesture; and
an application for interpreting said non-functional attributes as indicating a relative degree of functionality of said gesture.

2. The system of claim 1, wherein at least one of said attributes is size.

3. The system of claim 1, wherein at least one of said attributes is position.

4. The system of claim 1, wherein at least one of said attributes is size and another is position.

5. The system of claim 1, wherein said application responds to said non-functional attributes in proportion to said relative degree of functionality.

6. A gesture-based communication method, comprising:
interpreting at least one or more non-functional attributes of a gesture as indicating a relative degree of functionality of said gesture.

7. The method of claim 6, wherein at least one of said attributes is size.

8. The method of claim 6, wherein at least one of said attributes is position.

9. The method of claim 6, wherein at least one of said attributes is size and another is position.

10. The method of claim 6, further comprising:
responding to said non-functional attributes in proportion to said relative degree of functionality.

11. A method for facilitating workflow, comprising:
establishing a communication link between an interface and an application; and
utilizing gesture input to trigger functionality at said application via said communication link, wherein said gesture input includes a gesture component and at least one of a size component and position component modifying said gesture component.

12. The method of claim 11, further comprising:
receiving a response from said application.

13. The method of claim 11, further comprising:
authenticating said communication link.

14. The method of claim 11, further comprising:
using said gesture input to perform at least one of data acquisition, data retrieval, order entry, dictation, data analysis, image review, image annotation, display modification, and image modification.

15. The method of claim 11, further comprising:
displaying a response from said application.

16. The method of claim 11, wherein said gesture input corresponds to a sequence of application commands for execution by said application.

17. The method of claim 11, wherein said interface or application includes a default translation between said gesture input and said functionality.

18. The method of claim 11, further comprising:
customizing a translation between said gesture input and said functionality for at least one of a user and a group of users.

19. A computer-readable medium having a set of instructions for execution on a computer, said set of instructions comprising:
an input routine configured to receive gesture-based input at an interface, said input routine capturing a gesture and a characteristic associated with said gesture-based input; and
a translation routine configured to translate between said gesture-based input and an application function, said translation routine modifying said application function corresponding to said characteristic of said gesture-based input.

20. The computer-readable medium of claim 19, wherein said translation routine includes a default translation.

21. The computer-readable medium of claim 19, wherein said translation routine allows customization of said translation between said gesture-based input and said application function.

22. The computer-readable medium of claim 19, wherein said translation routine allows configuring at least one of an additional gesture-based input and application function.

23. The computer-readable medium of claim 19, wherein said gesture-based input corresponds to a sequence of application functions.

24. The computer-readable medium of claim 19, wherein said gesture-based input facilitates a workflow using said application function.

25. The computer-readable medium of claim 19, wherein said characteristic includes at least one of a position and a size of said gesture.

26. A method for associating a gesture with an application function, comprising:
mapping a gesture to an application function; and
modifying said mapping based on a characteristic associated with said gesture.

27. The method of claim 26, wherein said characteristic includes at least one of a position and a size of said gesture.

28. The method of claim 26, further comprising:
storing said modified mapping.

29. The method of claim 28, wherein said storing comprises storing said modified mapping for at least one of a user and a group of users.

30. The method of claim 26, wherein said modified mapping is created dynamically during use.

31. The method of claim 26, wherein said modified mapping corresponds to a sequence of application functions.

32. The method of claim 26, wherein said application function comprises a healthcare application function.
